(19) United States
(12) Patent Application Publication
(10) Pub. No.: US 2016/0049820 A1
(43) Pub. Date: Feb. 18, 2016

(54) Electrical Energy Storage Systems, Electric Drive Systems, Controllers, and Electrical Power Management Systems

(71) Applicants: Ramon Anthony CAAMAÑO, (US); Michael J. LEE, (US)

(72) Inventors: Ramon Anthony Caamaño, Gilroy, CA (US); Michael J. Lee, Carmel, CA (US)

(21) Appl. No.: 14/776,353

(22) PCT Filed: Mar. 12, 2014
(86) PCT No.: PCT/US14/23907

§ 371 Date: Sep. 14, 2015

Related U.S. Application Data
(60) Provisional application No. 61/786,033, filed on Mar. 14, 2013.

(51) Int. Cl. H02J 7/00; B60L 11/18

(52) U.S. Cl. CPC H02J 7/0065; B60L 11/1864; B60L 11/1879

(57) ABSTRACT

An electrical energy storage system includes a plurality of electrical energy storage modules with each module having an associated operating voltage and each module being capable of outputting electrical power at a variable current at the associated operating voltage. The system further includes a plurality of electrical power modulation circuits electrically connected to an associated one of the modules thereby allowing the associated module to be electrically isolated from the other modules. Each power modulation circuit includes an arrangement for receiving the operating voltage and current of the associated module, transforming the operating voltage and current, and outputting electrical power at a voltage that is independent of the module operating voltage of the associated electrical energy storage module. The system further includes an overall master controller electrically connected to each of the power modulation circuits of each module to control the electrical power output from each of the modules.

### RELATED APPLICATION

The present application claims priority from U.S. Provisional Patent Application Ser. No. 61/786,003 filed on Mar. 14, 2013 and which is hereby incorporated by reference in its entirety.

### BACKGROUND

The electric vehicle industry is continuously searching for cost effective electrical energy storage systems and electric drive systems with increased efficiency and power density. For some time now, it has been believed that electric machines such as electric motors and/or generators constructed using permanent super magnet rotors (for example cobalt rare earth magnets and Neodymium-Iron-Boron magnets) and stators including electromagnets with magnetic cores formed from thin film soft magnetic material have the potential to provide substantially higher efficiencies and power densities compared to conventional electric machines. However, it has proved very difficult to provide a cost effective electrical energy storage system and electric drive system that take full advantage of these potential efficiencies.

Variable speed electric machines used in an electric vehicle are typically controlled by a controller that uses a battery pack voltage from a battery pack that is normally made up of a number of electrically interconnected battery cells. The battery cells have an operating battery cell voltage that is usually dependent upon the type of cell used and the overall battery pack voltage is usually dictated by the battery pack configuration. The battery pack voltage is typically increased by interconnecting groups of individual battery cells in series to obtain a desired battery pack voltage and multiple groups of series connected battery cells are typically connected in parallel to increase the current capabilities of the overall battery pack.

Many electric vehicles currently use lithium-ion battery packs due to their relatively high power density and their ability to recharge repeatedly. In order to provide the performance characteristics necessary for this type of application, these lithium-ion battery packs are often designed to operate at relatively high voltages and relatively high current flows. The use of high voltages may create significant safety issues and there may be significant reliability issues associated with a battery pack that includes a large number of parallel-connected groups of battery cells. However, many high performance electric motors have optimum voltage operating points that may be higher than are typically available with lithium-ion battery systems because the voltage and size of a Lithium-ion battery pack may be restricted due to safety concerns.

### SUMMARY

In some aspects, the present disclosure provides a power management system and method for use with an electrical energy storage system. The electrical energy storage system includes a plurality of electrical energy storage modules with each electrical energy storage module having an associated electrical energy storage module operating voltage. Each electrical energy storage module is capable of outputting electrical power at a variable current at the associated operating voltage. The electrical energy storage system includes a plurality of electrical power modulation circuits with each electrical power modulation circuit being electrically connected to an associated one of the electrical energy storage modules thereby allowing the associated electrical energy storage module to be electrically isolated from the other electrical energy storage modules of the electrical energy storage system. Each electrical power modulation circuit includes an arrangement for receiving the operating voltage and current of the associated electrical energy storage module, transforming the operating voltage and current, and outputting electrical power at a voltage that is independent of the electrical energy storage module operating voltage of the associated electrical energy storage module. The electrical energy storage system further includes an overall master controller that is electrically connected to each of the electrical power modulation circuits of each electrical energy storage module to control the electrical power output from each of the electrical energy storage modules and thereby control the power output of the overall electrical energy storage system. In some aspects, each electrical energy storage module includes a plurality of individual battery cells with each battery cell having an associated battery cell operating voltage.

In some aspects, the individual battery cells are lithium-ion battery cells.

In some aspects, the battery cells making up different electrical energy storage modules of the energy storage system have different energy storage characteristics.

In some aspects, the battery cells making up different electrical energy storage modules of the energy storage system have different lithium-ion chemistries and different energy storage densities.

In some aspects, the plurality of battery cells making up each electrical energy storage module are all connected in series.

In some aspects, each electrical power modulation circuit includes a buck/boost converter for transforming the operating voltage of the associated electrical energy storage module to a voltage that is independent of and that may be higher than the operating voltage of the associated electrical energy storage module.

In some aspects, different electrical energy storage modules of the electrical energy storage system have different characteristics selected from a group of characteristics consisting of different operating voltages and different energy, impedance, and current capabilities.

In some aspects, the overall master controller is a motor controller and the electrical energy storage system is an electrical energy storage system for use with an electric motor including a rotor having a plurality of rotor poles.

In some aspects, the electric motor is a brushless DC motor/generator.

In some aspects, the overall master controller includes a plurality of independent controllers. Each independent controller is electrically connected to an associated electrical power modulation circuit to independently control the associated electrical power modulation circuit and the associated electrical energy storage module. The independent electrical power modulation circuits cooperate to create a single drive function for driving the electric motor.

In some aspects, the overall master controller includes a plurality of independent controllers with each independent controller being electrically connected to an associated electrical power modulation circuit to independently control the associated electrical power modulation circuit and the associated electrical energy storage module. The electric motor includes a stator having a plurality of independent stator modules with each independent stator module including a plurality of stator poles for magnetically interacting with the rotor poles. Each stator module is electrically connected to an associated independent controller and thereby electrically connected to an associated electrical power modulation circuit and electrical energy storage module to form a plurality of electrically independent sub-motors that are each capable of operating independently relative to the other sub-motors.

In some aspects, each stator module includes a set of coils for electrically energizing the stator poles. The set of coils has one or more coil sub-sets with each coil sub-set being associated with a different magnetic phase of the stator module and with all of the coils making up each coil sub-set being electrically connected in series.

In some aspects, the electric motor powers a vehicle.

In some aspects, the electric motor is a direct drive wheel motor.

In some aspects, the overall master controller applies a variable drive voltage to the electric motor.

In some aspects, the overall master controller applies a variable drive current to the electric motor.

In some aspects, the electric motor is a multi-phase motor and the overall master controller applies a variable drive voltage and current function to each phase of the electric motor by pulse width modulating the applied drive voltage across the phase and by varying the voltage of the applied drive voltage.

In some aspects, the overall master controller varies the drive voltage and current function in a manner that changes with one or more of the speed of the electric motor, a requested electric motor power output, and an optimization of efficiency, response, lifetime, smoothness, and maximum available power.

In some aspects, the overall master controller increases the drive voltage as the speed of the electric motor increases and as the requested electric motor power output increases using a predetermined function.

In some aspects, the overall master controller switches the drive voltage applied to the electric motor using pulse width modulation to control the amount of electric energy provided to the electric motor. The overall master controller also varies the switching speed of the pulse width modulation in a manner that changes with one or more of the speed of the electric motor and a requested electric motor power output.

In some aspects, the overall master controller varies the drive voltage and the switching speed of the pulse width modulation applied to the electric motor to optimize one or more of the efficiency of the electric motor, the power of the electric motor, the heating of the electric motor, the noise of the electric motor, the speed and torque of the electric motor, and the life of the electrical energy storage system.

In some aspects, the overall master controller and the electrical power modulation circuits of each electrical energy storage module allow electrical energy to be discharged from a given electrical energy storage module only when the overall master controller requests electrical energy to be discharged from the given electrical energy storage module.

In some aspects, each electrical power modulation circuit includes at least a pair of power terminals through which electrical energy is discharged from the associated electrical energy storage module. The power terminals are controlled by the electrical power modulation circuit associated with the electrical energy storage module to activate the power terminals and allow electrical energy to be discharged from the electrical energy storage module only when the overall master controller requests electrical energy to be discharged from the electrical energy storage module.

In some aspects, the overall master controller includes a plurality of independent controllers. Each independent controller is electrically connected to an associated electrical power modulation circuit to independently control the associated electrical power modulation circuit and the associated electrical energy storage module. The electrical energy storage system includes at least one auxiliary electrical energy storage module having an associated auxiliary electrical energy storage module operating voltage and an auxiliary electrical power modulation circuit for electrically isolating the auxiliary electrical energy storage module from the other electrical energy storage modules of the electrical energy storage system. The auxiliary electrical power modulation circuit includes an arrangement for receiving the auxiliary electrical energy storage module operating voltage and current of the auxiliary electrical energy storage module, transforming the operating voltage and current, and outputting a voltage and current that is independent of the auxiliary electrical energy storage module operating voltage of the auxiliary electrical energy storage module. The auxiliary electrical energy storage module is electrically connected to, and is controlled by, the independent controller associated with the given one of the electrical energy storage modules.

In some aspects, each electrical energy storage module includes a module housing for housing the electrical energy storage module and the associated electrical power modulation circuit. The module housing includes a length of extruded, thermally conductive material and end caps for sealing the ends of the length of extruded material.

In some aspects, the end caps provide a watertight seal and the extruded material is extruded aluminum having a cross-sectional shape that includes at least one heat-dissipating flange and a heat-dissipating surface configured to be attached to a heat dissipating support.

In some aspects, the present disclosure provides a motor controller and method for controlling a variable speed electric motor powered by an electrical power source having a power source operating voltage. The controller includes a voltage varying arrangement for receiving the power source operating voltage from the power source, transforming the operating voltage and outputting a variable drive voltage that may be applied to the electric motor and that is independent of the power source operating voltage. The controller also includes a switching arrangement that switches and applies the variable drive voltage to the electric motor using pulse width modulation to control the amount of electric energy provided to the electric motor. The controller varies the switching speed of the pulse width modulation and varies the variable drive voltage in a manner that changes with one or more of the speed of the electric motor and a requested electric motor power output.

In some aspects, the controller varies the switching speed of the pulse width modulation and varies the variable drive voltage applied to the electric motor to optimize one or more of the efficiency of the electric motor, the power of the electric motor, the heating of the electric motor, the noise of the electric motor, the speed and torque of the electric motor, and the life of the electrical power source.

In some aspects, the controller varies the switching speed of the pulse width modulation and varies the variable drive voltage applied to the electric motor as the speed of the electric motor varies and as the requested electric motor power output varies using a predetermined function.

In some aspects, the electrical power source includes at least one lithium-ion battery cell.

In some aspects, the present disclosure provides a battery pack module for use in an electrical energy storage system. The battery pack module includes at least one battery cell and a module housing for housing the battery cells. The module housing includes a length of extruded, thermally conductive material and end caps for sealing the ends of the length of extruded material.

In some aspects, the end caps provide a watertight seal and the extruded material is extruded aluminum having a cross-sectional shape that includes at least one heat-dissipating flange and a heat-dissipating surface configured to be attached to a heat dissipating support.

In some aspects, the battery cells are lithium-ion battery cells.

In some aspects, the battery cells are all connected in series.

In some aspects, the battery cells are electrically interconnected to provide a battery pack voltage and the battery pack further includes an electrical power modulation circuit that is configured to be controlled by an external controller such that the battery pack voltage is not accessible from outside of the battery pack unless it is commanded by the external controller.

In some aspects, the battery pack module is configured for use in an electrical storage system having a plurality of battery pack modules and the electrical power modulation circuit is configured to allow the battery pack module to be disabled and electrically isolated from the system.

In some aspects, the battery pack module includes a plurality of parallel-connected groups of battery cells, each parallel-connected group includes at least one battery cell, and the parallel-connected groups of battery cells are electrically connected to one another in series.

In some aspects, the battery pack module includes a cell balancing arrangement that is electrically connected to each of the parallel-connected groups of battery cells such that the energy taken from the battery pack module may be taken from a subset of the parallel-connected groups of battery cells.

In some aspects, the cell balancing arrangement takes energy from a subset of the parallel-connected groups of battery cells such that the battery pack module delivers the energy from the subset of the parallel-connected groups of battery cells into an electrical device or other external electrical load that is electrically connected to the battery pack module during the use of the battery pack module thereby providing a cell balancing function for the battery pack module during the use of the battery pack module.

### DESCRIPTION OF DRAWINGS

FIG. 1 is a schematic illustration of a power management system for use with an energy storage system and electric drive system in accordance with aspects of the present disclosure.

FIG. 2 is a schematic illustration of an electric drive system in accordance with aspects of the present disclosure.

FIG. 3 is a cross sectional view of the electric machine of FIG. 2.

FIG. 4 is a perspective view of a stator segment of the electric machine of FIG. 2.

FIG. 5 is a plan view of a winding used to provide a stator core of a stator segment of FIG. 4.

FIG. 6 is a plan view of two stator cores of a stator segment of FIG. 4.

FIG. 7 is a schematic illustration of another embodiment of an electric drive system in accordance with aspects of the present disclosure.

FIG. 8 is a schematic illustration of an electrical energy storage module and an associated auxiliary electrical energy storage module in accordance with aspects of the present disclosure.

FIG. 9 is a cross-sectional view of the module housing of the electrical energy storage module of FIG. 8.

FIG. 10 is a flow chart illustrating the steps of a controller method in accordance with aspects of the present disclosure.

FIG. 11 is a graph of a single magnetic cycle of a single phase of an exemplar electric machine in accordance with aspects of the present disclosure with the y-axis representing voltage and the x-axis representing time.

Like reference numerals in the various drawings indicate like elements.

### DETAILED DESCRIPTION

Aspects of the present disclosure are generally directed to electrical energy storage systems, electric drive systems, controllers, and power management systems. Aspects of the present disclosure also relate to methods and arrangements for controlling a relatively large battery system such as a battery pack for use in an electric vehicle. Aspects of the present disclosure further provide methods and arrangements for electrically interconnecting and controlling components of electrical energy storage systems and electric drive systems that include electric machines such as electric motors and/or generators that are powered by electrical energy storage systems.

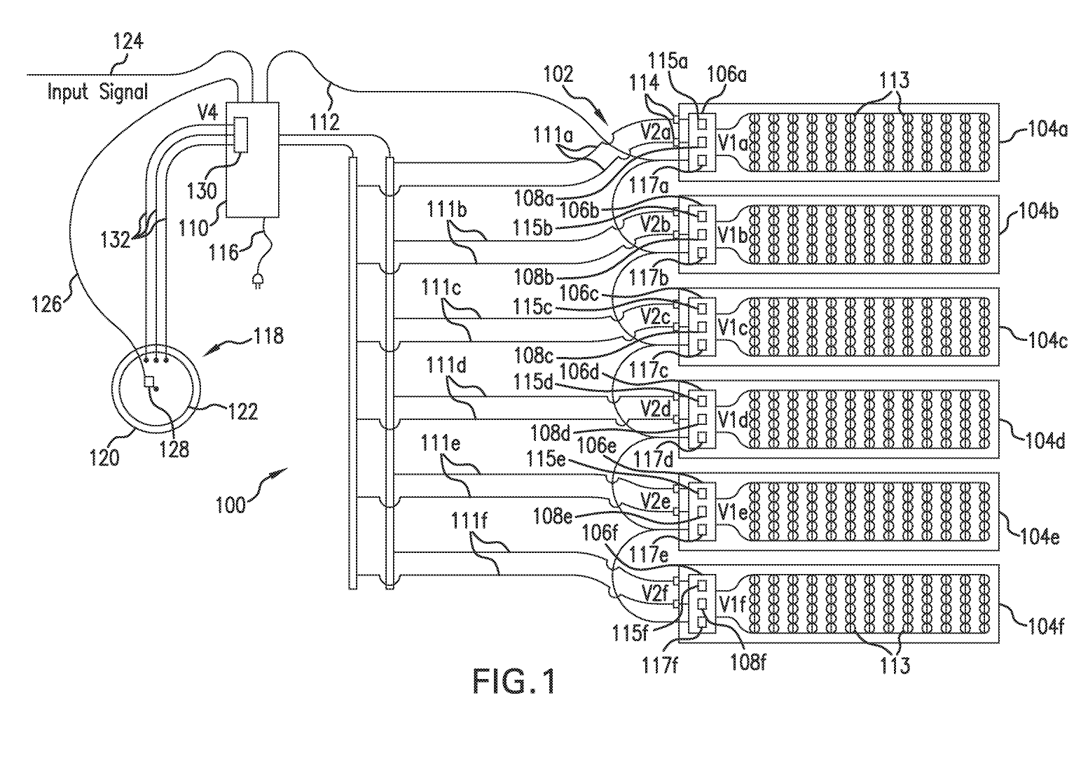

Referring initially to FIG. 1, a general overall power management system 100 for use with an electrical energy storage system 102 in accordance with aspects of the present disclosure will be described. Electrical energy storage system 102 includes a plurality of electrical energy storage modules 104 with each electrical energy storage module 104 having an associated electrical energy storage module operating voltage V1. In the embodiment illustrated in FIG. 1, electrical energy storage system 102 includes six electrical energy storage modules 104 indicated by reference numerals 104a through 104f with each module having an associated module operating voltage indicated by reference characters V1a through V1f respectively. Although electrical energy storage system 102 is described as including six modules, this is not a requirement. Instead, the energy storage system may include any desired number of modules.

Electrical energy storage system 102 further includes a plurality of electrical power modulation circuits 106. In the embodiment illustrated in FIG. 1, electrical energy storage system 102 includes six electrical power modulation circuits 106 indicated by reference numerals 106a through 106f. Each of the electrical power modulation circuit 106a-f is electrically connected to an associated one of electrical energy storage modules 104a-f to allow each associated electrical energy storage module 104 to be electrically isolated from the other electrical energy storage modules of electrical energy storage system 102. In accordance with aspects of the present disclosure, electrical power modulation circuits 106a-f may be incorporated as part of electrical energy storage modules 104a-f as illustrated in FIG. 1. As will be described in more detail hereinafter, this may provide significant safety advantages for the energy storage system. Alternatively, the electrical power modulation circuits may be provided as separate components that may be electrically connected to the electrical energy storage modules rather than included as integral parts of the modules.

As will be described in more detail hereinafter, each electrical power modulation circuit 106a-f includes a respective output arrangement 108a-f for receiving the electrical energy storage module operating voltage V1a-f and current from the associated electrical energy storage module, transforming the operating voltage and current, and outputting an output voltage V2 and current that is independent of the electrical energy storage module operating voltage V1a-f. Electrical energy storage system 102 further includes an overall master controller 110 that is electrically connected to each of electrical power modulation circuits 106a-f. In this embodiment, pairs of electrical conductors 111 (indicated by reference numerals 111a through 1110 are used to transmit electrical power between controller 110 and electrical power modulation circuits 106a-f respectively. Controller 110 is configured to control the operation of electrical power modulation circuits 106 using a communication bus 112 that interconnects controller 110 with electrical power modulation circuits 106a-f. Communication bus 112 may be any desired type of communication bus such as, but not limited to, a CAN bus. With this configuration, controller 110 may control the electrical power output from each of the electrical energy storage modules, and thereby control the power output of overall electrical energy storage system 102. Communication bus 112 may also be used to communicate the condition of each of the electrical energy storage modules as part of an energy storage management system.

In accordance with some aspects of the present disclosure, each electrical energy storage module 104 may include one or more electrical energy storage components 113 for storing electrical energy. In a preferred embodiment, electrical energy storage components 113 may be lithium-ion battery cells having a desired lithium-ion battery cell chemistry and a battery cell voltage V3. Although the various embodiments described herein will be described as using lithium-ion battery cells as the electrical energy storage components used to store electrical energy in the energy storage modules, it should be understood that this is not a requirement. Instead, any electrical energy storage component may be used including other types of battery cells, various types of capacitors such as super capacitors, electrical energy storage flywheels, or any other electrical energy storage component.

In accordance with another aspect of the present disclosure, different electrical energy storage modules 104 that are included in electrical energy storage system 102 may have different electrical energy storage module characteristics such as different module operating voltages V1. For example, in the case in which the electrical energy storage modules included battery cells as the electrical energy storage components 113, the battery cells of one electrical energy storage module may have different energy storage characteristics compared to the battery cells of another electrical energy storage module. These characteristics may be different lithium-ion chemistries and/or different energy storage densities. Additionally, the battery cells making up each electrical energy storage module may be interconnected in a variety of ways. For example, all of the battery cells of one electrical energy storage module may be connected in series. Alternatively, the cells making up another electrical energy storage module may be connected in any combination of parallel and series to provide a desired module operating voltage V1 and current capacity for that electrical energy storage module. In situations in which different electrical energy storage modules of the system have different module operating voltages, each of the output arrangements 108 may be used to transform the different module operating voltages of the different modules to the same output voltage V2.

Overall master controller 110 and electrical power modulation circuits 106a-f of each electrical energy storage module 104a-f may be configured to allow electrical energy to be discharged from a given electrical energy storage module 104 only when overall master controller 110 requests electrical energy to be discharged from that electrical energy storage module 104. For example, each electrical energy storage module 104a-f may include a pair of power terminals 114 through which electrical energy is discharged from the associated electrical energy storage module 104. Power terminals 114 may be controlled by electrical power modulation circuit 106 to activate power terminals 114 and allow electrical energy to be discharged from the electrical energy storage module only when overall master controller 110 requests electrical energy to be discharged from the electrical energy storage module.

Each electrical energy storage module 104a-f may further include a charger 115 indicated by reference numerals 115a through 115f for charging the electrical energy storage components of the electrical energy storage module. Chargers 115a-f may be controlled by controller 110, which may use communication bus 112 to communicate with and control the operation of chargers 115a-f. Controller 110 may include an external electrical power input 116 for receiving electrical power from an external source for charging electrical energy storage system 102 using chargers 115a-f. Although chargers 115a-f have been described as being included in their respective electrical energy storage modules, it should be understood that this is not a requirement. Instead, the chargers may be provided in a variety of locations including, but not limited to, being included in controller 110 or being provided as separate components that are electrically connected to controller 110 and energy storage modules 104a-f.

In a preferred embodiment, each of the output arrangements 108a-f of electrical power modulation circuits 106a-f may include a buck/boost converter 117 indicated by reference numerals 117a through 117f that is controlled by controller 110. Again, controller 110 may use communication bus 112 to communicate with and control the operation of buck/boost converters 117a-f. Buck/boost converters 117a-f may be electrically connected to their respective electrical energy storage components 113 to receive their respective electrical energy storage module operating voltages V1a-f and transform this module operating voltage to the output voltage V2 that is independent of and that may be higher or lower than the module operating voltage V1a-f.

As illustrated in FIG. 1, power management system 100 and electrical energy storage system 102 may be systems for use with an electric machine 118. Electric machine 118 may include, but is not limited to, an electric motor and/or an electric generator that has a rotor assembly 120 and a stator assembly 122. Controller 110 may be an electric machine controller that regulates operation of electric machine 118 based on an input signal 124 and a position signal 126. Input signal 124 may include a requested electric machine torque or power output such as a throttle signal in the case where electric machine 118 is implemented in a vehicle, motorcycle, scooter, or the like. Electric machine 118 may also include a Hall Effect sensor or other position detecting arrangement 128 for detecting the position of rotor assembly 120 relative to stator assembly 122. The Hall Effect sensor or other position detecting arrangement 128 may generate position signal 126 used by controller 110. Controller 110 may regulate power provided to electric machine 118 from electrical energy storage system 102 when electric machine 118 is operating in a motor mode. Furthermore, electric machine 118 may generate power that may be provided to, and stored in, electrical energy storage system 102 when electric machine 118 is operating in a generator mode.

Although the position detecting arrangement has been described as a Hall Effect sensor, it should be understood that this is not a requirement. Instead, any available and readily providable position detecting arrangement may be used. For example, in situations in which high frequency electric motors are being used, a capacitive encoder may be used.

Although electric machine 118 will be described primarily herein as being provided as a DC brushless motor, electric machine 118 may be provided as one of a variety of other types of electric machines and remain within the scope of the present disclosure. This includes, but is not limited to, DC synchronous electric machines, variable reluctance or switched reluctance electric machines, and induction type electric machines. For example, the rotor poles of electric machine 118 may be provided as permanent magnets in the case where electric machine 118 is provided as a DC brushless electric machine. In the case of a switched reluctance electric machine, or an induction electric machine, the rotor poles may be provided as protrusions of other magnetic materials formed from laminations of materials such as iron or preferably thin film soft magnetic materials. In other arrangements, the rotor poles may be provided as electromagnets.

In accordance with another aspect of the present disclosure, controller 110 may apply a variable drive voltage V4 and current to electric machine 118. As will be described in more detail hereinafter, controller 110 may vary drive voltage V4 and current in a manner that changes with the speed of the electric machine and/or the requested electric machine torque or power output that may be part of input signal 122. Controller 110 may increase drive voltage V4 as the speed of electric machine 118 increases and as the requested electric motor torque or power output increases using a predetermined function. Controller 110 may also vary the drive voltage and current to optimize one or more of the efficiency of the electric motor, the power of the electric motor, the heating of the electric motor, the noise of the electric motor, the speed and torque of the electric motor, the life of the electrical energy storage system, or any other function of the system.

Controller 110 may also include a switching arrangement 130 for switching the drive voltage V4 and current applied to electric machine 118 using pulse width modulation to control the amount of electric energy provided to electric machine 118. In accordance with another aspect of the present disclosure, controller 110 may vary the switching speed of switching arrangement 130 to vary the switching speed of the pulse width modulation applied to electric machine 118. Controller 110 may also vary both the drive voltage and the switching speed of the pulse width modulation used to drive electric machine 118. This approach may be used to optimize one or more of the efficiency of the electric motor, the power of the electric motor, the heating of the electric motor, the noise of the electric motor, the speed and torque of the electric motor, the life of the electrical energy storage system, or any other function of the system.

In a preferred embodiment, controller 110 controls buck/boost converters 117a-f in each of the electrical power modulation circuits 106a-f of each electrical energy storage modules 104a-f to cause each module to output electrical energy at a desired output voltage V2. This output voltage V2 is selected to be equal to a desired drive voltage V4. Controller 110 may use pulse width modulation to control the amount of electrical energy that is provided to electric machine 118 and the controller may select a desired switching speed for the pulse width modulation. Both the drive voltage and the switching speed of the pulse width modulation may be varied to optimize the operation of the electric machine. In order to achieve this, and as will be described in more detail hereinafter, the electric machine and overall system may be fully characterized or tested to determine the optimum drive voltage and switching speed for pulse width modulation for the entire operating range of the system. The results of this testing may be compiled into lookup tables or operating functions. These tables or functions may be included in the system and may be available to controller 110 such that controller 110 may select and use the desired drive voltage and switching speed for pulse width modulation for any given situation throughout the operating range of the system.

Electric machine 118 may be a three-phase electric motor and controller 110 may use three electrical conductors 132 to provide drive voltage V4 to electric machine 118. Although electric machine 118 has been described as being a three-phase electric motor, this is not a requirement. Instead, the electric machine may utilize any desired number of phases and remain within the scope of this disclosure. As would be understood by one skilled in the art, with the above described configuration, the number of electrical conductors 132 used to electrically connect the controller to the electric motor and provide the drive voltage to the motor would depend upon the number of phases used in the motor.

Although the controller has been shown in FIG. 1 as being a single overall controller, it should be understood that this is not a requirement. Instead, the controller may be provided in a variety of ways. For example, the overall controller may include a plurality of independent sub-controllers with each independent sub-controller being electrically connected to an associated electrical power modulation circuit to independently control the associated electrical power modulation circuit and the associated electrical energy storage module.

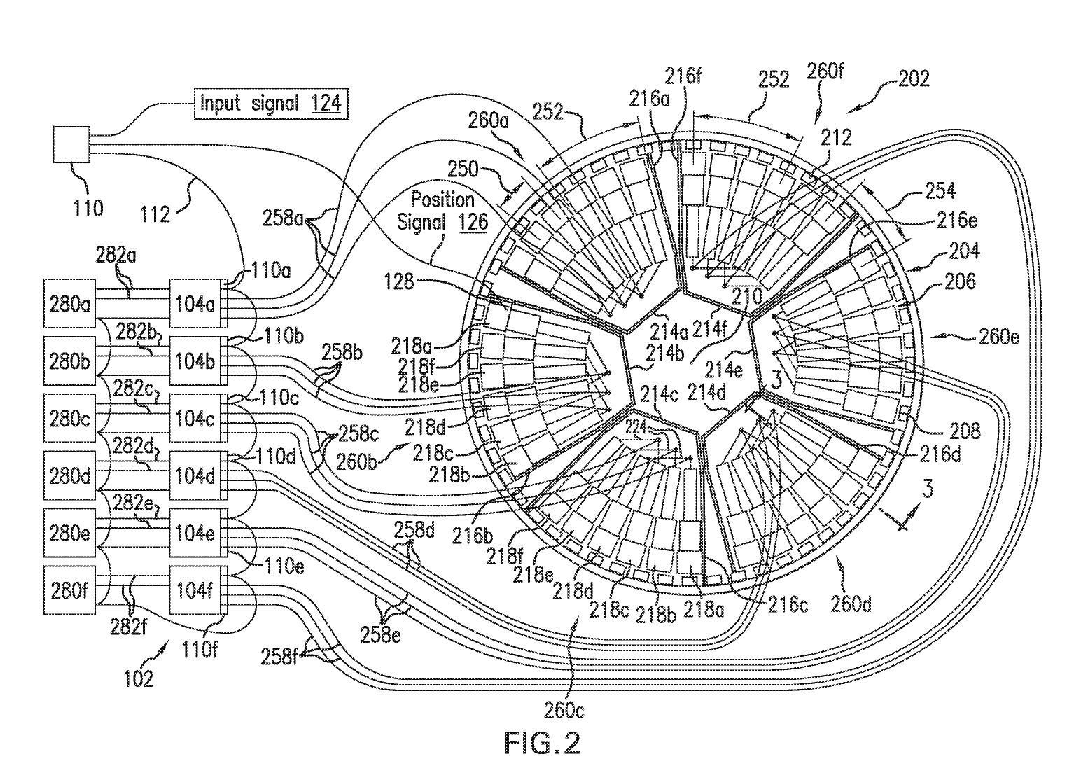

Now that a general overall power management system designed in accordance with aspects of the present disclosure has been described with reference to FIG. 1, a specific preferred embodiment of an electric drive system 200 in accordance with aspects of the present disclosure will be described with reference to FIGS. 1 and 2. In this embodiment, system 200 is an electric drive system for use with a variable speed electric motor/generator that powers an electric vehicle.

As was described above for power management system 100, system 200 includes electrical energy storage system 102 with six electrical energy storage modules 104 indicated by reference numerals 104a through 104f. Each electrical energy storage module 104 has an associated electrical energy storage module operating voltage V1 indicated by reference characters V1a through V1f respectively. As mentioned above, although electrical energy storage system 102 is described as including six modules, this is not a requirement. Instead, the energy storage system may include any number of modules.

Each of the electrical energy storage modules 104a-f of system 200 further includes an associated electrical power modulation circuit 106 respectively indicated by reference numerals 106a through 106f. As mentioned above, electrical power modulation circuits 106a-f can be used to electrically isolate each associated electrical energy storage module 104 from the other electrical energy storage modules of electrical energy storage system 102. Each of the electrical power modulation circuits 106a-f also includes an output arrangement 108 respectively indicated by reference numerals 108a through 108f for receiving the electrical energy storage module operating voltage V1a-f of its associated electrical energy storage module, transforming the operating voltage, and outputting an output voltage V2a-f that is independent of the electrical energy storage module operating voltage V1a-f. In this embodiment, output arrangements 108a-f of electrical power modulation circuits 106a-f include buck/boost converter 117a-f respectively. Each of the electrical energy storage modules 104a-f of system 200 may further include an associated charger 115 respectively indicated by reference numerals 115a through 115f.

Each electrical energy storage module 104 of system 200 also includes a plurality of individual electrical energy storage components 113 for storing electrical energy. In this specific embodiment, each electrical energy storage module 104 includes seventy-eight individual lithium-ion battery cells having Nickel-Cobalt-Manganese oxide cathodes, graphite anodes, and a battery cell voltage V3 that is about 3.7 volts. The seventy-eight battery cells are electrically interconnected with thirteen groups of six battery cells that are connected in parallel to form thirteen parallel-connected groups of cells. The thirteen parallel-connected groups of battery cells each have a nominal operating voltage of about 3.7 volts and they are connected in series to provide a nominal module operating voltage V1 of about 48 volts. As mentioned above, although this embodiment is described as using lithium-ion battery cells interconnected to provide a module operating voltage of 48 volts, it should be understood that this is not a requirement. Instead, any desired electrical energy storage component may be used and these components may be interconnected in any desired way to provide any desired module operating voltage. For example, the same seventy-eight battery cells described above may be all connected in series to provide a module with a module operating voltage of about 288 volts. In addition, although all of the electrical energy storage modules of this specific embodiment are described as having the same configuration and module operating voltage, this is not a requirement. Instead, each electrical energy storage module may have a configuration and module operating voltage that is different from the other electrical energy storage modules of the system.

Although each energy storage module has been described as including a single electrical power modulation circuit 106, it should be understood that each module may include multiple electrical power modulation circuits. For example, the same seventy-eight battery cells described above may be electrically interconnected with thirteen parallel-connected groups of six battery cells. Each of the thirteen parallel-connected groups of six cells may have its own electrical power modulation circuit to allow each parallel-connected group to be electrically isolated from the other parallel-connected groups of the module. The electrical power modulation circuits associated with all thirteen parallel-connected groups of battery cells may then be connected in series to provide a nominal module operating voltage V1 of about 48 volts.

As was described above for system 100, system 200 further includes overall master controller 110 that is electrically connected to each of electrical power modulation circuits 106a-f to control the operation of electrical power modulation circuits 106a-f. However, in system 200, controller 110 includes six sub-controllers 110a through 110f that are included respectively within, or as an integral part of, electrical energy storage modules 104a through 104f. Master controller 110 controls and coordinates the operation of sub-controllers 110a-f and each of the sub-controllers 110a-f is configured to control their respective electrical power modulation circuits 106a-f and buck/boost converters 117a-f to cause each electrical energy storage module to output a desired electrical output at the desired output voltage V2a-f. As will be described in more detail hereinafter, these output voltages V2a-f may all be the same voltage, or alternatively, these output voltages may be different voltages.

System 200 further includes electric machine 202. In this embodiment, electric machine 202 is provided as a radial gap electric machine with rotor assembly 204 located around the outer perimeter of electric machine 202 and a stator assembly 206. Electric machine 202 is a brushless DC motor/generator in which rotor assembly 204 has a plurality of permanent magnet rotor poles located around the inner perimeter of rotor assembly 204 and electric machine 202 is a direct drive wheel motor that powers a vehicle.

As was described above for system 100, controller 110 regulates operation of electric machine 202 based on an input signal 124 and a position signal 126. In this embodiment, input signal 124 includes a requested electric machine torque or power output such as a throttle signal. Electric machine 202 also includes a Hall Effect sensor or other position detecting arrangement 128 for detecting the position of rotor assembly 204 relative to stator assembly 206. The Hall Effect sensor or other position detecting arrangement 128 generates position signal 126 used by controller 110.

In the arrangement of FIG. 2, rotor assembly 204 is located around the outer perimeter of electric machine 202. That is, stator assembly 206 is surrounded by rotor assembly 204. Although not illustrated in FIG. 2, rotor assembly 204 may be supported by bearings to rotate relative to stator assembly 206. A radial gap 208 separates rotor assembly 204 from stator assembly 206. In alternative arrangements, rotor assembly 204 may be supported for rotation relative to stator assembly 206 about a rotational axis 210 using other suitable means. Although electric machine 202 is described as a radial gap machine with the stator assembly being surrounded by the rotor assembly, this is not a requirement. Instead, the machine may be a radial gap machine with the stator assembly surrounding the rotor assembly. Alternatively, the rotor assembly and the stator assembly may be axially adjacent to one another forming an axial gap machine.

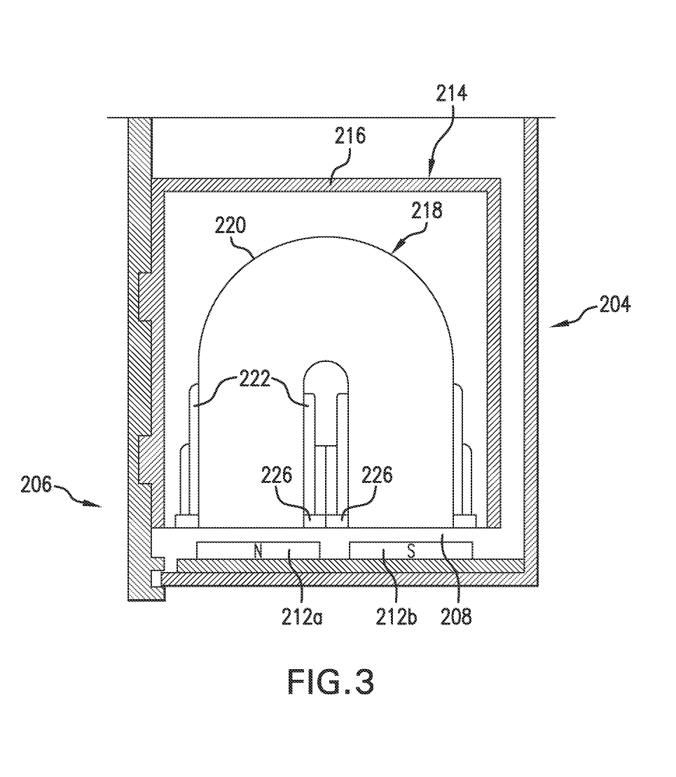

In the embodiment of FIG. 2, rotor assembly 204 includes fifty-six pairs of radially adjacent permanent magnets 212 that form the rotor poles of rotor assembly 204. In some implementations, the pairs of permanent magnets 212 may be provided as super magnets such as cobalt rare earth magnets, or any other suitable or readily providable magnet material. As illustrated best in the cross sectional view of FIG. 3, each of the pairs of permanent magnets 212 includes a first magnet oriented to form a north rotor pole 212a, and a second magnet oriented to form a south rotor pole 212b. The first magnet is located adjacent to the second magnet such that the two permanent magnets are in line with one another along a line that is generally parallel with the rotational axis 210 of electric machine 202. Accordingly, the two permanent magnets define adjacent circular paths about the rotational axis 210 of electric machine 202 when rotor assembly 204 rotates. As shown in FIG. 3, the permanent magnet pairs are positioned around the inside periphery of rotor assembly 204 facing radial gap 208. Each consecutive pair of permanent magnets 212 is reversed such that all of the adjacent magnet segments alternate from north to south around the entire rotor assembly 204.

Although permanent magnet pairs 212 may be provided as permanent super magnets, other magnetic materials can be implemented. In some embodiments, electromagnets may be implemented with rotor assembly 204 in place of permanent magnets. In addition, although rotor assembly 204 of FIG. 2 is illustrated as including fifty-six magnet pairs, it is contemplated that rotor assembly 204 may include any number of magnet pairs.

Stator assembly 206 includes a plurality of stator modules 214. In the arrangement of FIG. 2, stator assembly 206 includes six stator modules 214, which are designated by reference numerals 214a though 214f in FIG. 2 for descriptive purpose. Although stator assembly 206 is described as including six stator modules 214, other arrangements are contemplated. For example, stator assemblies including more than six stator modules 214 or less than six stator modules 214 are within the scope of the present disclosure.

Each stator module 214 of electric machine 202 is independent from the other stator modules 214 in stator assembly 206. More specifically, each stator module 214 is independently removable and replaceable. In some implementations, a stator module 214 may be removed, and electric machine 202 can operate with less than a full complement of stator modules 214. Considering the specific arrangement of FIG. 2, for example, electric machine 202 may operate with more or less than six stator modules 214. That is, electric machine 202 of FIG. 2 may operate with one, two, three, four, five, six, or seven stator modules 214. In addition, the stator modules used may be arranged symmetrically or asymmetrically. For example, if two stator modules are used, stator modules 214a and 214b may be used to form an asymmetrical version of electric machine 202. Alternatively, modules 214a and 214d may be used to form a symmetrical version of electric machine 202.

In electric machine 202, each stator module 214 includes a stator module housing 216 and at least one stator segment 218 housed within stator module housing 216. Preferably, each stator segment 218 is identical to all of the other stator segments of electric machine 202. In the arrangement of FIG. 2, electric machine 202 is provided as a three-phase electric machine, and each stator module 214 includes six stator segments 218 that are designated by reference numerals 218a through 218f respectively.

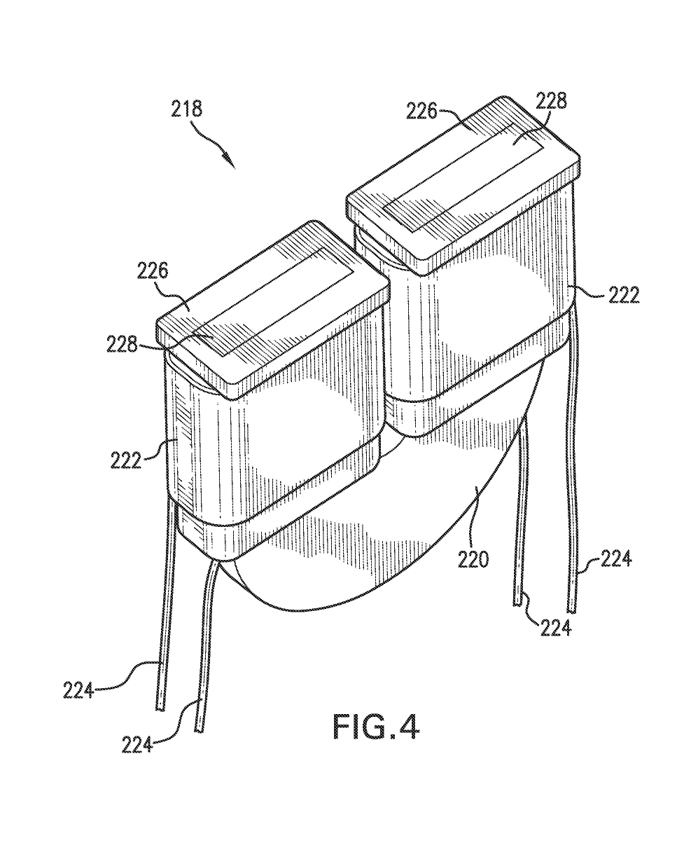

As best illustrated in FIG. 4, each stator segment 218 includes a magnetic core 220 and two independent coils 222. Each magnetic core 220 is a U-shaped magnetic core with one of coils 222 positioned around each leg of core 220. Since magnetic cores 220 include legs that have a consistent cross section, the electromagnetic windings or coils 222 may be slid over each of the legs of core 220 after coils 222 have already been formed or wound. This allows each individual coil 222 to be economically wound on a high volume and very simple winding machine. This ability to wind coils 222 individually and prior to being installed onto cores 220 eliminates the need for the use of expensive and complicated winding machines to perform the complex winding processes that are typically required to manufacture conventional electric machines.

In this example, round copper wire with a dielectric coating may be used to form coils 222. However, it should be understood that any desired electrical conductor material and configuration may be used. This includes wire formed from electrically conductive material other than copper such as aluminum. This also includes wire stock having any desired cross sectional shape such as square wire or foil.

As also illustrated in FIG. 4, independent coils 222 include two electrical leads 224 for electrically interconnecting each coil with other coils of the electric machine. With this configuration, electrical leads 224 of coils 222 may be interconnected in a variety of different desired manners depending on the specific requirements for the electric machine. For example, in a three phase electric machine, a six stator segment stator module would include six pairs of coils for a total of twelve coils 222 with two of these pairs of coils, or two stator segments, being associated with each phase. In a relatively low voltage version of this type of electric machine, each group of two pairs of coils associated with each phase may be electrically interconnected in parallel. In a relatively higher voltage version of this type of electric machine, each group of two pairs of coils associated with each phase may be electrically interconnected in series. In a relatively medium voltage version of this type of electric machine, each group of two pairs of coils associated with each phase may be electrically interconnect such that there are two parallel groups of two coils connected in series. Therefore, a plurality of different stator module and electric machine configurations may be obtained by simply using different configurations to interconnect electrical leads 224 of coils 222 without varying any other components within stator module. This provides the advantage of being able to use many of the same components to construct a variety of electric machine configurations.

In this embodiment, each stator segment 218 may also include a core bracelet 226 attached to the sides of the U-shaped core at the ends of each of the legs of the U-shaped core. Core bracelets 226 may be configured to fully surround the ends of U-shaped core 220 to provide an enlarged stator pole face 228 at each end of core 220. The use of core bracelet 226 also allows the ends of core 220 to extent through core bracelets 226 so that the ends of core 220 make up at least portions of stator pole face 228. Core bracelets 226 may be formed from thin film soft magnetic material, powdered metal, or any other desired magnetic material. In a preferred embodiment, core bracelets are formed from magnetically permeable metal powder that is pressed into the desired shape. As illustrated best in FIG. 4, core bracelets 226 may have a uniform thickness perpendicular to stator pole face 228. This use of a uniform thickness allows core bracelet 226 to be easily and economically pressed from a powdered metal material.

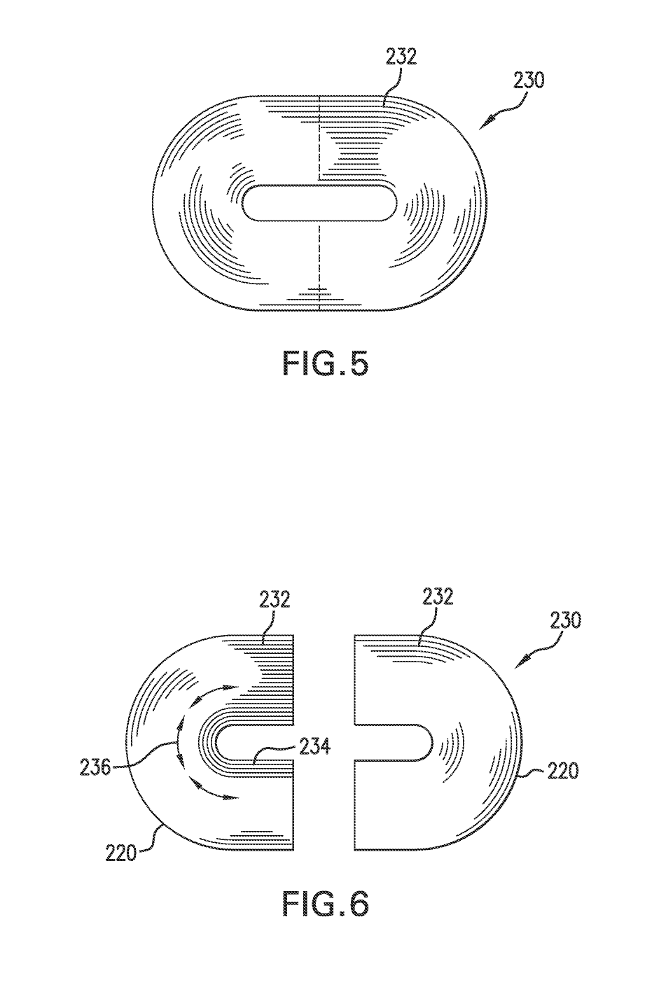

Referring now to FIGS. 5 and 6, the specific configuration of an exemplar magnetic core 220 for the particular embodiment of electric machine 202 shown in FIG. 2 will be described in more detail. In this embodiment, each individual one-piece magnetic core 220 is formed by winding a continuous ribbon of thin film soft magnetic material into a desired shape. In this example, the shape is a generally oval shape as indicated by winding 230 in FIG. 5. These types of electric machines that may include tape wound magnetic cores are described in more detail in U.S. Pat. Nos. 6,603,237, 6,879,080, 7,030,534, and 7,358,639 and PCT patent applications PCT/US2010/048019, PCT/US2010/048027, and PCT/US2010/048028, all of which are incorporated herein by reference and all of which are by applicant.

Thin film soft magnetic low loss materials such as amorphous metal or nano-crystalline material are normally supplied in a thin continuous tape having a uniform tape width. Many other magnetic materials may also be provided in the form of a long continuous tape. For purposes of this description, the term tape wound magnetic cores is meant to include any magnetic core formed by winding a thin tape magnetic material into a coil to form a magnetic core.

Since thin film soft magnetic materials such as amorphous metal or nano-crystalline materials are typically provided in very thin tape or ribbon form (for example, a few thousandths of an inch or mil thick or even less than 1 mil thick), winding 230 may be made up of hundreds of winds or layers of material as illustrated by lines 232 in FIGS. 5 and 6. Once wound into the desired shape, winding 230 may be annealed to remove any stresses that may have been caused by the winding process. Winding 230 may also be saturated with an adhesive material such as a very thin wicking epoxy that may be heat cured to bind winding 230 into a rigid piece.

Once annealed, thin film soft magnetic materials may be very hard and very brittle making them somewhat difficult to machine. In the embodiment shown in FIGS. 5 and 6, winding 230 requires only one cut in order to cut winding 230 into two U-shaped pieces. Each U-shaped piece may provide one of magnetic cores 220. As illustrated in FIG. 6, each of the two U-shaped pieces that result from cutting winding 230 are made up of a plurality of concentric U-shaped layers 234 of thin film soft magnetic material.

In some implementations, core 220 may be made from a nano-crystalline, thin film soft magnetic material. In other implementations, any thin film soft magnetic material may be used, and can include, but are not limited to, materials generally referred to as silicon iron, amorphous metals, materials similar in elemental alloy composition to amorphous metal materials that have been processed in some manner to further reduce the size of the crystalline structure of the material, and any other thin film materials. Although the thin film soft magnetic material making up cores 220 has been primarily described as amorphous metal or nano-crystalline material, the present disclosure is not limited to these specific materials. Instead, any magnetic material that can be provided as a thin continuous tape or ribbon may be used to provide a tape wound magnetic core as described herein.

One advantage to the above described core configuration is that when assembled into an electromagnetic assembly as described above, each one-piece magnetic core provides the entire return path for the two stator poles formed by the legs of the U-shaped magnetic core. This eliminates the need for a back iron to magnetically interconnect all of the stator poles. This elimination of the need for a back iron reduces the inductance of an electric machine using this type of core configuration. This reduced inductance assists in allowing for more efficient high frequency switching of the magnetic field in the magnetic cores.

Another advantage of the above described configuration is that there are no parasitic gaps within the magnetic cores. That is, each layer of thin film soft magnetic material extends continuously from one end or pole of the U-shaped magnetic core all the way around to the opposite end or pole of the U-shaped magnetic core. Therefore, this configuration orients each of the layers of thin film soft magnetic material in the proper orientation for directing magnetic flux through the magnetic core along the length of each layer of thin film soft magnetic material as illustrated by arrow 236 in FIG. 6.

As mentioned above, electric machine 202 of FIG. 2 includes fifty-six pairs of permanent magnets evenly spaced around rotor assembly 204 and each stator module 214 includes six stator segments 218. The stator segments 218 within a given stator module 214 are arranged with a particular stator segment spacing 250 between adjacent stator segments 214. In this example, electric machine 202 is configured to have a rotor pole to stator pole ratio of four to three. That is, four pairs of permanent magnets fit within a given arc 252 of electric machine 202 and three adjacent stator segments 218 of a given stator module fit within arc 252. Although electric machine 202 will be described as using a rotor pole to stator pole ratio of four to three for descriptive purposes, this is not a requirement. Instead, any desired ratio between the number of rotor poles relative to stator poles may be used and still remain within the scope of the present disclosure.

Arc 252 corresponds to one fourteenth of the diameter of electric machine 202 since four evenly spaced permanent magnets fit within arc 252 and electric machine includes a total of fifty-six permanent magnets 212 evenly spaced around rotor assembly 204. This means that there is space for a total of forty-two stator segments 218 around stator assembly 206 if the stator assembly is fully populated with stator segments evenly spaced at stator segment spacing 250. Therefore, an electric machine of this configuration with a full complement of forty-two stator segments 218 may have seven stator modules that each include six evenly spaced stator segments 218.

As mentioned above, electric machines in accordance with aspects of the present disclosure may use less than a full complement of stator modules. Additionally, specific stator module designs and electric machine designs may make it difficult to maintain a constant stator segment spacing between the stator segments at the ends of adjacent stator modules. For example, the thicknesses of the stator module housings of two adjacent stator modules may be such that it is not possible to maintain a constant stator segment spacing between the stator segments at the ends of the adjacent stator modules. Therefore, specific electric machine and stator module designs, or the use of less than a full complement of stator modules within a particular electric machine design, may create a stator pole gap larger than the stator segment spacing between adjacent stator segments within the associated stator modules.

In the specific embodiment of FIG. 2, electric machine 202 includes only six evenly spaced stator modules 214 with each stator module including only six stator segments 218. This results in a total of thirty-six stator segments within stator assembly 206 even though forty-two stator segments would fit in electric machine 202 if a full complement of stator segments were used with constant stator segment spacing 250. In other words, six of the potential forty-two stator segments are omitted in electric machine 202. This use of fewer than a full complement of stator segments 218 within stator assembly 206 results in a stator pole gap 254 between the stator segments at the ends of adjacent stator modules. This stator pole gap 254 is larger than the stator segment spacing 250 between adjacent stator segments within stator modules 214. In electric machine 202, stator pole gap 254 is twice the size of stator segment spacing 250 because six potential stator segments are omitted and the six stator modules are spaced equally around stator assembly 206. These larger stator pole gaps may lead to issues with regard to controlling the timing of the switching of the magnetic fields of the stator segments. However, as will be described in more detail hereinafter, these larger stator pole gaps may be accounted for using the control methods for the modular design described herein.

As described above, each stator segment 218 within each stator module is preferably identical to all of the other stator segments in all of the other stator modules of the electric machine. This modular configuration provides several advantages over conventional electric machines.

First, by using a certain stator segment design for all of the stator segments of a particular electric machine, the magnet core and the windings that are used for the stator segment may be economically produced in mass quantities. In the case of a magnetic core that is formed from thin film soft magnetic material, this is a very significant advantage because of the difficulties associated with manufacturing magnetic cores using these types of materials. Electric motors that use magnetic cores formed from thin film soft magnetic material may provide significant advantages over conventional iron core electric motors because thin film soft magnetic material can operate at very high frequencies without incurring high core losses. However, the difficulties associated with manufacturing magnetic cores for electric motors using these low loss materials have previously prevented these materials from becoming commercially successful in electric motors.

In addition to using the same magnetic core design for all of the stator segments of a particular electric machine, the same magnetic core design may be used for an entire family of electric machines. This may be accomplished by providing a variety of configurations of windings and a variety of stator module housings and other components that are associated with the same magnetic core design. Each electric machine associated with the family of machines would then use the one magnetic core design along with a particular winding configuration and a particular stator module housing. This may further increase the economies of scale associated with producing the particular magnetic core and associated family of electric machines.

In another advantage of the modular design described above, the same electric machine design may be used to provide a variety of electric machines with different power outputs. For example, in the case in which the electric machine is used as a hub motor for an electric vehicle application, the same basic motor design may be used to provide an entry-level vehicle with modest power output, a mid-level vehicle with moderate power output, and a high-end vehicle with high power output. In a specific example of this approach, an electric hub motor for a vehicle may be designed to include space for up to six stator modules. An entry-level vehicle may be provided with two stator modules included in the motor, a mid-level vehicle may be provided with four stator modules included in the motor, and a high-end vehicle may be provided with six stator modules included in the motor. This approach enables the same basic motor design to be used for all three power levels of vehicle, which significantly reduces the costs associated with both developing the vehicle design and manufacturing the vehicle. This approach also provides the unique ability to upgrade the motor to a higher performance motor later, by adding one or more stator modules.

Most conventional electric motors are designed to operate at 50 to 60 Hz because these are the frequencies available on conventional AC electrical power grids. One of the reasons AC power is typically provided at these frequencies is that these frequencies are well within the frequency capabilities of a conventional iron core motor. Even in the case of specialty prior art motors, the frequencies typically remain below 400 Hz. This is because conventional iron core materials cannot respond to the changing magnetic fields any more quickly than this without causing very large losses that show up in the form of heat.

As described above, the electric machine designed in accordance with the present disclosure may use low loss thin film soft magnetic material to form the magnetic cores of the stator segments. The use of low loss thin film soft magnetic material for the core material of an electric machine allows for operation at very high frequencies while maintaining high efficiency. These frequencies may be substantially greater than 400 Hz while still providing extremely high efficiencies and may be operated at frequencies as high as or greater than for example 2500 Hz.

As mentioned above with regard to FIG. 2, electric machine 202 includes six stator modules 214a-f and electrical energy storage system 102 includes six electrical energy storage modules 104a-f. In accordance with another aspect of the present disclosure and as illustrated in FIG. 2, each of the stator modules 214a-f is electrically connected to a respective one of the electrical energy storage modules 104a-f using electrical conductors 258a-f respectively to form six independent sub-motors 260a-f. That is, stator module 214a is electrically connected to electrical energy storage module 104a using electrical conductors 258a to form sub-motor 260a, stator module 214b is electrically connected to electrical energy storage module 104b using electrical conductors 258b to form sub-motor 260b, and so on. With this configuration, each of the sub-motors 260a-f may be operated independently of the other sub-motors.

As also mentioned above, each of the electrical energy storage modules 104a-f includes an associated sub-controller 110a-f. Each sub-controller 110a-f is configured to respectively control its associated electrical power modulation circuit 106a-f and electrical energy storage module 104a-f to provide or receive electrical power to or from its associated stator module 214a-f. Again, this configuration provides six electrically independent sub-motors 260a-f that are each capable of operating independently relative to the other sub-motors. In this embodiment, overall master controller 110 may be used to control and coordinate the operation of the sub-controllers 110a-f and sub-motors 260a-f using communication bus 112 in a manner similar to that described above for system 100.

In the embodiment of FIG. 2, three electrical conductors are used to electrically connect each of the electrical energy storage modules 104a-f respectively to its associated stator module 214a-f since electric machine 202 is described as being a three phase machine. Although machine 202 is described as being a three phase machine, this is not a requirement. Instead, the electric machine may be any number of phases and may use the appropriate number of conductors to electrically connect each electrical energy storage module 104 to its associated stator module 206.

Although the configuration of electric machine 202 is described in detail as including a specific type of stator modules having a specific type of stator segments, this is not a requirement. Instead, the electric machine may be implemented in a wide variety of configurations. For example, a more conventional electric machine configuration may be used and the windings or coils of the machine may be separated in to a desired number of groups of windings or coils with each group being associated with one of the electrical energy storage modules to form a sub-motor.

As described above, system 200 provides an electric drive system including a plurality of independent sub-motors 260 that include a stator module 214 and an electrical energy storage module 104. In a preferred embodiment, each of the stator modules 214 may be identical to the other stator modules in the system and each of the electrical energy storage modules 104 may be identical to the other electrical energy storage modules of the system. This modular configuration provides several advantages over conventional electric drive systems.

First, by using a certain stator module design and electrical energy storage module design for a particular electric drive system, all of the components of the stator modules and electrical energy storage modules may be more economically produced in higher quantities. As mentioned above in the case of a magnetic core that is formed from thin film soft magnetic material, this is a very significant advantage because of the difficulties associated with manufacturing magnetic cores using these types of materials.

Second, the stator modules and electrical energy storage modules may be designed to be easily removable and replaceable. This may significantly improve the serviceability and reliability of this type of system compared to conventional electric drive systems by providing multiple redundancies in the system. For example, if there is a component failure such as a short in a motor winding or a battery cell failure, the sub-motor associated with that failed component may be shut down and the other sub-motors may continue to function normally. This would allow the system to continue to function at a reduced performance that is proportional to the number of remaining functional sub-motors compared to the total number of sub-motors. This shutting down of the sub-motor with the failed component allows continued use of the system without risking further damage to the system rather than needing to completely shut down the overall system. This may provide a significant safety advantage in applications such as a vehicle drive system where there may be significant safety concerns associated with shutting down the system due to a component failure while the system is in use. This approach may also significantly reduce the cost and time required to repair the system by requiring only the stator module or electrical energy storage module associated with the failed component to be replaced rather than requiring the entire motor or battery pack to be removed and repaired or replaced.

As mentioned above, the same electric machine design may be used to provide a variety of electric machines with different power outputs by including different numbers of sub-motors. This approach also provides the unique ability to upgrade the motor to a higher performance motor later by adding one or more sub-motors. Additionally, the same electrical energy storage system design may be used to provide a variety of systems with different energy storage capacities by including different numbers of electrical energy storage modules. As will be described in more detail hereinafter, this approach also provides the unique ability to upgrade the energy storage system to a larger capacity system later by adding one or more additional electrical energy storage modules.

The modular design of the present disclosure also allows the use of smaller electronic components for each of the sub-motors compared to what would be required for a conventional drive system that uses a single overall motor and battery pack with a similar performance level. For example, the sub-controllers and buck/boost converters associated with each sub-motor may use substantially smaller MOSFETs and/or other electronic components than would be required if a single overall motor, controller, and battery pack were to be used. This may reduce the switching losses and may reduce the costs associated with the electronic components by allowing the use of more common sized components that may be produced in higher volume and may be more economical compared to larger less common components that may be required for a more conventional design. The use of smaller MOSFETs and/or other electronic components may also eliminate the need to factory match the components because of lower individual power levels.

As described above, the use of multiple sub-motors allows the coils of the overall electric machine to be grouped in a wide variety of ways depending on the requirements of the application. This allows a motor in accordance with this disclosure to be configured such that each sub-motor operates at a substantially lower drive voltage than would be practical for a conventional motor of the same output. This may provide substantial safety advantages compared to conventional higher voltage electric drive systems. Additionally, depending upon the specific drive voltages that are used for the sub-motors, much smaller electrical conductors may be used to connect each electrical energy storage module to its associated stator module compared to what would be required for connecting a single large battery pack to a single large motor. These smaller electrical conductors may carry much lower amperages and may provide additional safety advantages compared to conventional electric drive systems.

Another significant advantage of using the modular drive and energy storage systems of the present disclosure is that parallelism in both the motor and the battery pack may be reduced dramatically, or even eliminated altogether. This may improve the efficiency of the system by reducing or eliminating ring currents in the motor.

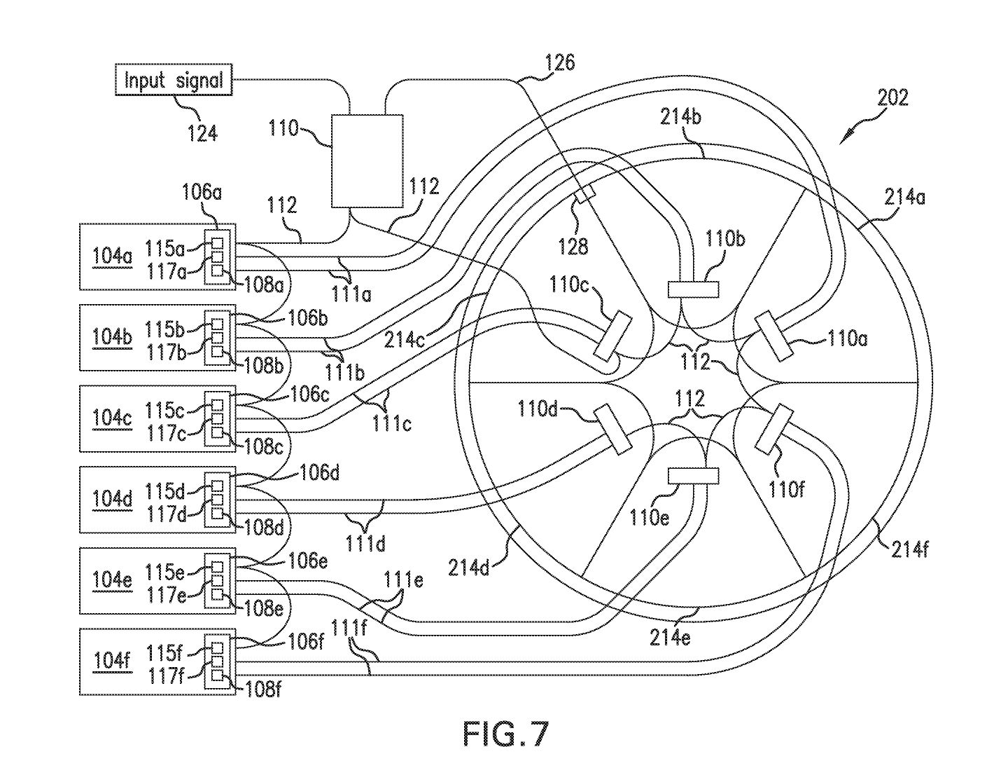

Although independent sub-controllers 110a-f of FIG. 2 are shown as being included as part of the electrical energy storage modules 104a-f, this is not a requirement. Instead, sub-controllers 110a-f may be provided as separate components that are electrically connected at some point between the electrical energy storage modules and the stator modules. Alternatively, each of the sub-controllers 110a-f may be respectively included as an integral part of their associated stator modules 214a-f of electric machine 202 as illustrated in FIG. 7. With this configuration, pairs of electrical conductors 111a-f similar to those described above for FIG. 1 may be used to allow electrical power to flow between each of the electrical energy storage modules 104a-f and their associated stator modules 214a-f. Since the sub-controllers 110a-f would create the desired electrical phases within the stator modules, electrical conductor pairs 111a-f may be used rather than using the multiple phase specific electrical conductors 258a-f of FIG. 2.

The above described approach may also be used to reduce or even eliminating the need for resistive balancing, or some other form of balancing, of the parallel-connected groups of battery cells that are connected in series. As described above, if desired, each group of parallel-connected battery cells may have its own electrical power modulation circuit to allow each parallel-connected group of battery cells to be electrically isolated from the other parallel-connected groups of the module. The electrical power modulation circuits associated with the parallel-connected groups of battery cells may then be connected in series to provide the module operating voltage. With this configuration, each electrical power modulation circuit associated with each parallel-connected group of battery cells may be used to effectively balance the parallel-connected groups of battery cells by either discharging excess power during the use of the system or by regulating the amount of power stored in the associated parallel-connected group of battery cells during the charging of the module. Alternatively, the modular energy storage systems of the present disclosure may be used to provide a battery management system that efficiently balances parallel-connected groups of battery cells that are connected in series.

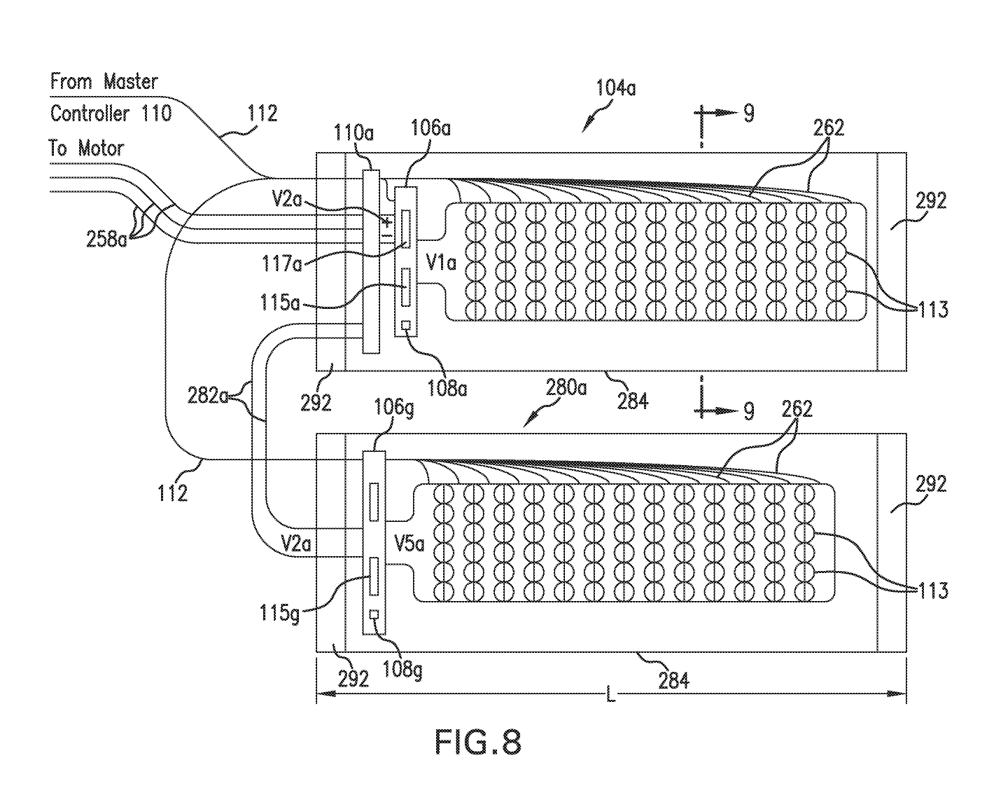

As illustrated best in FIG. 8 and as described above, electrical energy storage module 104a includes seventy eight battery cells 113 with thirteen groups of six parallel-connected batteries. In this embodiment, electrical energy storage module 104a includes fourteen sensing/discharge wires 262 that are connected to the interconnected battery cells to sense the voltage associate with each parallel-connected group of battery cells. Sensing/discharge wires 262 are also connected to sub-controller 110a such that sub-controller 110a may use sensing/discharge wires 262 to independently discharge any one of the parallel-connected groups of battery cells.

The combination of sensing/discharge wires 262 and sub-controller 110a provide a cell balancing arrangement that is electrically connected to each of the parallel-connected groups of battery cells such that the energy taken from the battery pack module may be taken from a subset of the parallel-connected groups of battery cells. This configuration also provides a cell balancing arrangement that may take energy from a subset of the parallel-connected groups of battery cells such that the battery pack module delivers the energy from the subset of the parallel-connected groups of battery cells into an electrical device or other external electrical load that is connected electrically to the battery pack module.

In accordance with aspects of this disclosure, the cell balancing function described above may occur during the use of the battery pack module thereby providing a cell balancing function for the battery pack module during the normal use of the battery pack module. This allows the energy taken from the battery cells during the cell balancing function to be used more efficiently compared to conventional cell balancing arrangements since the power taken from the battery cells during the cell balancing function may be used to power the device that is electrically connected to and powered by the battery pack module.

In accordance with another aspect of the present disclosure, the electrical energy storage system may include at least one auxiliary electrical energy storage module 280a having an associated auxiliary module operating voltage V5a as illustrated best in FIG. 8. Electrical energy storage module 280a may include an electrical power modulation circuit 106g similar to those described above for electrical energy storage module 104a-f. As was described above, electrical power modulation circuit 106g may include an output arrangement 108g for receiving the auxiliary module operating voltage V5a and current, transforming the operating voltage and current, and outputting a voltage and current such as output voltage V2a that is independent of the auxiliary module operating voltage and current of auxiliary electrical energy storage module 280a.

As was described above for energy storage modules 104a-f, each auxiliary electrical energy storage module may include one or more electrical energy storage components 113 for storing electrical energy. In a preferred embodiment, electrical energy storage components 113 may be lithium-ion battery cells having a desired lithium-ion battery cell chemistry and a battery cell voltage V3. Although the various embodiments described herein are described as using lithium-ion battery cells as the electrical energy storage components used to store electrical energy in the energy storage modules, it should be understood that this is not a requirement. Instead, any electrical energy storage component may be used including other types of battery cells, various types of capacitors such as super capacitors, electrical energy storage flywheels, or any other electrical energy storage component.

Furthermore, different auxiliary electrical energy storage modules may have different module characteristics such as different module operating voltages. For example, in the case in which the auxiliary modules included battery cells as the electrical energy storage components, the battery cells of one auxiliary module may have different energy storage characteristics compared to the battery cells of another auxiliary module. These characteristics may be different lithium-ion chemistries and/or different energy storage densities. Additionally, the battery cells making up each auxiliary module may be interconnected in a variety of ways. For example, all of the battery cells of one module may be connected in series. Alternatively, the cells making up another module may be connected in any combination of parallel and series to provide a desired module operating voltage. In situations in which different modules of the system have different module operating voltages, each of the output arrangements may be used to transform the different module operating voltages of the different modules to the same output voltage if desired.

As illustrated in the specific embodiment of FIG. 2, electric drive system 200 includes six auxiliary electrical energy storage modules indicated by reference numerals 280a through 280f. Each of the auxiliary modules 280a-f is electrically connected to an associated electrical energy storage module 104a-f respectively. Although this embodiment shows each electrical energy storage module 104a-f connected to only one auxiliary electrical energy storage module, this is not a limitation. Instead, it is contemplated that any number of auxiliary electrical energy storage modules may be connected to each of the electrical energy storage modules 104a-f of the system.

Each of the auxiliary energy storage modules 280a-f of electric drive system 200 further includes an associated electrical power modulation circuit respectively indicated by reference numerals 106g through 106l. As mentioned above, electrical power modulation circuits 106g-l may be used to electrically isolate each associated auxiliary electrical energy storage module from the other electrical energy storage modules of electrical energy storage system 102. Each of the electrical power modulation circuits 106g-l also includes an output arrangement respectively indicated by reference numerals 108g through 108l. Each of the output arrangements is configured to receive the auxiliary electrical energy storage module operating voltage indicated by reference numerals V5a through V5f and transform and output an output voltage that is independent of the electrical energy storage module operating voltage V5a-f. In this embodiment, output arrangements 108g-l of electrical power modulation circuits 106g-l include buck/boost converters 117g-l respectively. Each of the auxiliary electrical energy storage modules 280a-f may further include an associated charger respectively indicated by reference numerals 115g through 115l. Alternatively, the chargers may be provided as separate components from the auxiliary modules or as parts of the associated energy storage modules 104a-f or portions of sub-controllers 110a-f of electrical energy storage modules 104a-f.

Each of the auxiliary electrical energy storage modules 280a-f is electrically connected to its associated sub-controller 110a-f of electrical energy storage modules 104a-f using a respective pair of electrical conductors 282a-f to allow electrical power to be transferred between the associated modules. Each of the auxiliary electrical energy storage modules 280a-f is also electrically connected to the sub-controllers 110a-f of electrical energy storage modules 104a-f using communications bus 112. This allows sub-controllers 110a-f to control the operation of their associated electrical power modulation circuits 106g-l and buck/boost converters 117g-l of auxiliary electrical energy storage modules 280a-f.

As described above, overall master controller 110 controls and coordinates the operation of sub-controllers 110a-f. With the auxiliary modules connected to the system, each of the sub-controllers is configured to control the respective electrical power modulation circuits and buck/boost converters of its associated electrical energy storage module and its associated auxiliary electrical energy storage module. That is, sub-controller 110a is configured to control electrical power modulation circuit 106a of module 104a and power modulation circuit 106g of auxiliary module 280a as well as control buck/boost converter 117a of module 104a and buck/boost converter 117g of auxiliary module 280a. Sub-controllers 110b-f similarly control the electrical power modulation circuits and buck/boost converters of their associated modules. As described above, sub-controllers 110a-f cause each electrical energy storage module and auxiliary energy storage module to output a desired electrical output at the respective desired output voltage V2a-f. In a system that includes auxiliary modules, the output voltage of a particular auxiliary module 280 may be controlled to be the same output voltage of its associated electrical energy storage module 104. However, the output voltages V2a-f associated with different pairs of modules may all be the same voltage, or alternatively, the output voltages V2a-f of the different pairs of modules may be different voltages.

As mentioned above, this modular approach to the electrical energy storage system allows auxiliary modules to be added to increase the energy storage capacity of the system. This approach may also provide more cost effective servicing of the system by allowing individual modules to be removed and repaired or replaced rather than requiring the entire electrical energy storage system to be removed and repaired or replaced.

As mentioned above, the chemistries of the battery cells making up the auxiliary modules may be different then the chemistry of the battery cells making up energy storage modules 104. In a preferred embodiment, the auxiliary modules may be modules that are made up of high energy density battery cells with much higher energy storage capacities compared to energy storage modules 104, but lower power capabilities. Energy storage modules 104 may be made up of battery cells with higher power capabilities, but lower energy storage capacities. With this approach, energy storage modules 104 may be used to handle any high power requirements of the system and the auxiliary modules may be used to store and provide larger amounts of energy over longer periods of time that may be used at a more moderate rate compared to a module using batteries with higher power capabilities.

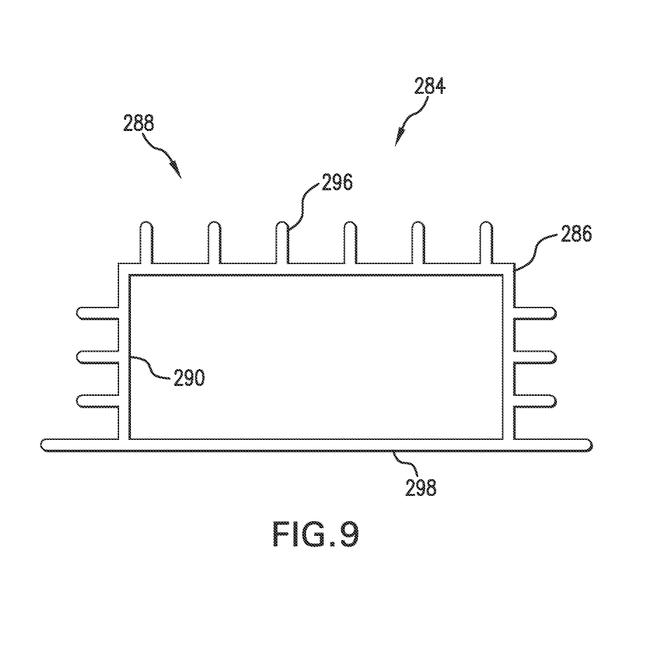

In accordance with another aspect of the present disclosure, each electrical energy storage module and/or auxiliary electrical energy storage module may include a module housing 284 for housing the components of the modules as illustrated in FIGS. 8 and 9. Module housing 284 may include a desired length L of an extrusion 286 having a desired cross-sectional shape 288. As illustrated in FIG. 9, cross-sectional shape 288 may include a peripheral wall 290 that defines an opening within which all of the components of the electrical energy storage module may be placed and supported. As described above, these electrical components may include an electrical power modulation circuit, an output arrangement, a sub-controller, electrical energy storage components, a charger, and a buck/boost converter. The extrusion is preferably made from a thermally conductive material that allows module housing 284 to assist in dissipating heat away from the components of the electrical energy storage module. In a preferred embodiment, the extrusion is anodized extruded aluminum, however, it should be understood that the extruded material may be any desired material such as a thermally conductive plastic or any other suitable and readily providable material.

Module housing 284 may include end caps 292 (best shown in FIG. 8) for sealing the ends of the length of extrusion and forming a complete enclosure. In a preferred embodiment, the end caps provide a watertight seal such that the module housing is hermetically sealed to protect the electrical components of the electrical energy storage module from moisture and other external elements. A potting material may be used to fill any remaining open spaces within the module housing and to form end caps 292 to seal the electrical components within the module. The potting material may be used to support the components within extrusion 286 and may be used to hermetically seal the electrical components within the module. This potting material may be thermally conductive in order to assist in removing heat from the electrical components of the module and electrically nonconductive to avoid shorting between the electrical components of the module. Alternatively, a thermally conductive gap pad may be used to assist in removing heat from the electrical components of the module.

As illustrated best in FIG. 9, the cross sectional shape 288 of the extruded material may include one or more heat dissipating flanges 296 and a heat dissipating surface 298 configured to be attached to a heat dissipating support. Furthermore, in embodiments in which the electrical energy storage components 113 take the form of battery cells such as lithium-ion battery cells, the electrical connections between the battery cells included in each module may be spot welded connections that may provide the best possible and most reliable electrical connections between the cells. The battery cells used within each module may also be factory matched based on certain cell characteristics such as, but not limited to, their cell voltage, impedance, their energy storage capacity, and/or any other cell characteristic to provide the most reliable module.

Referring back to FIG. 1, the present disclosure provides a motor controller (such as controller 110) and method for controlling a variable speed electric motor (such as electric machine 118). The variable speed electric motor is powered by an electrical power source (such as electrical energy storage system 102) having a power source operating voltage (such as module operating voltages V1a-f). The system includes a voltage varying arrangement for receiving the power source operating voltage and current from the power source, transforming the operating voltage, and outputting a variable drive voltage and current that may be applied to the electric motor and that is independent of the power source operating voltage. In the embodiment of FIG. 1, the voltage varying arrangement includes buck/boost converters 117a-f. The controller also includes a switching arrangement that switches and applies the variable drive voltage to the electric motor using pulse width modulation to control the amount of electric energy provided to the electric motor. This switching arrangement is provided by switching arrangement 130 on controller 110 in the embodiment of FIG. 1. In accordance with aspects of the present disclosure, the controller may vary the switching speed of the pulse width modulation and may vary the variable drive voltage in a manner that changes with at least the speed of the electric motor and/or a requested electric motor power output or requested electric motor torque.

As was also mentioned above and in accordance with aspects of the present disclosure, the controller may vary the switching speed of the pulse width modulation and may vary the voltage applied to the electric motor to optimize one or more of the operating characteristics of the electric drive system. These operating characteristics may include the efficiency of the electric motor, the power of the electric motor, the heating of the electric motor, the noise of the electric motor, the speed and torque of the electric motor, the life of the electrical power source, or any other desired operating characteristic of the drive system. The controller may use predetermined functions, look up tables, or other desired arrangements to determine the switching speeds and drive voltages to be used for any given situation within the operating range of the electric machine.

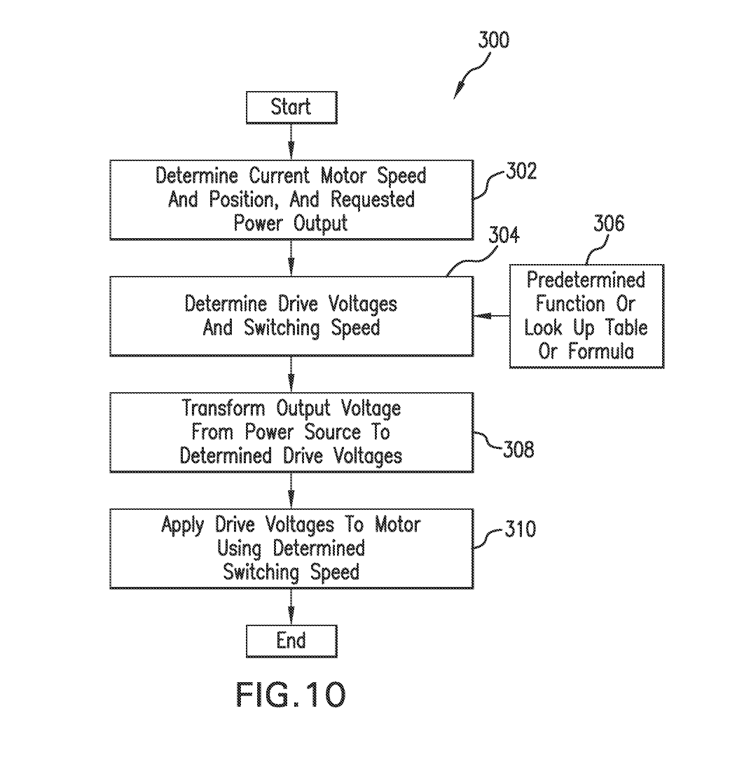

FIG. 10 illustrates a controller method 300 in accordance with the present disclosure. As indicated in step 302, the controller initially determines the current motor speed and position and the requested torque or power output. As described above for FIG. 1, this information may be provided by position detecting arrangement 128 using position signal 126 and by input signal 124. Based on this information, the controller determines the drive voltages to be applied to the motor and the switching speed to be used for the pulse width modulation of the drive voltage as indicated in step 304. As indicated in block 306, the controller uses predetermined functions to determine the drive voltages and switching speeds. These predetermined functions may be in the form of look up tables, formulas, or any other suitable and readily providable form. Once the drive voltages and switching speed are determined, the controller causes the output voltage and current from the power source to be transformed to the determined drive voltages as indicated by step 308. In the example of the system of FIG. 1, controller 110 causes buck/boost converters 117 to receive output voltage V2 and current from electrical energy storage components 113 and transform this output voltage to the determined drive voltage. Finally, as indicated in step 310, the controller applies the drive voltages to the motor using the determined switching speed. This may be accomplished using a switching arrangement such as switching arrangement 130 of FIG. 1 to apply the drive voltages using pulse width modulation that is switched at the determined switching speed.

As is the case with conventional electric machines, the electric machines of the present disclosure produce a counter EMF or back EMF with the magnitude of the voltage of the back EMF being dependent upon the field switching speed or rotational speed of the machine. Generally, the voltage of the back EMF increases as the field-switching frequency, and therefore the rotational speed of the machine increases. The back EMF of a given electric machine is also dependent upon the specific physical configuration of the electric machine. For example, the air gap between the rotor poles and stator poles, the magnet type and size, the type of material used to form the magnetic core, the number of turns on the coils, the interconnecting arrangement of the coils, the use of a back iron to magnetically connect the stator poles, and the size and shape of the magnetic core may all significantly affect the back EMF associated with a specific electric machine.

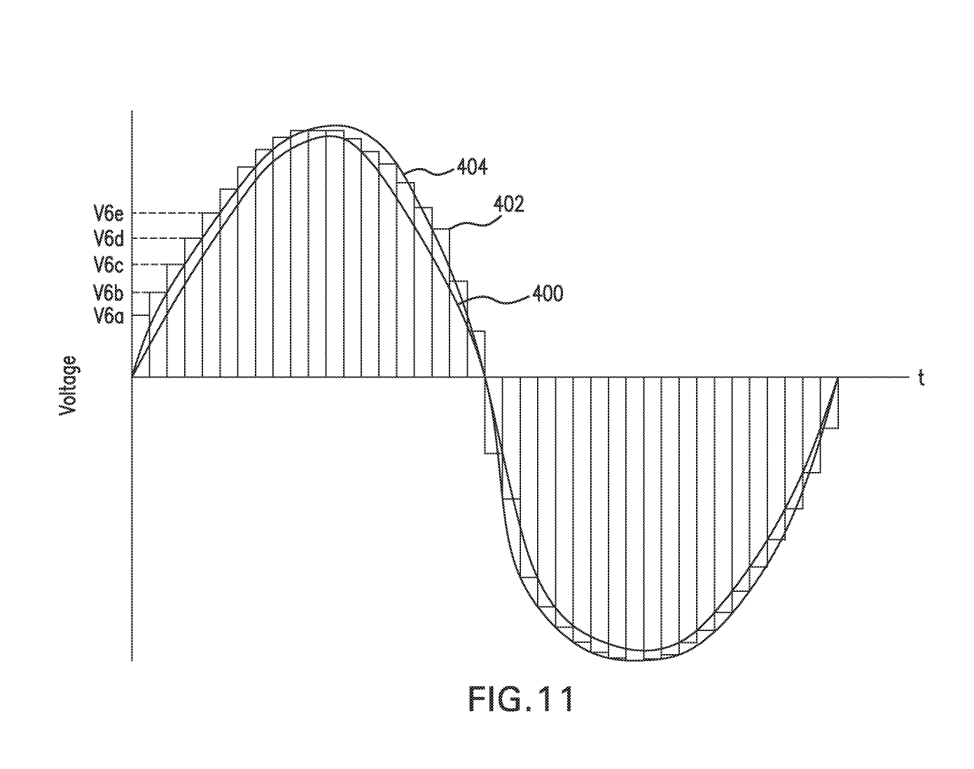

FIG. 11 is a graph associated with a single magnetic cycle of a single phase of an exemplar electric machine with the y-axis representing voltage and the x-axis representing time. Back EMF curve 400 illustrates the voltage of the back EMF associated with this specific example of this single cycle. In this example, the cycle is divided into forty equal length pulse intervals that are used for the pulse width modulation of a drive voltage V6 indicated by stepped drive voltage line 402. Each pulse interval may have an associated pulse interval voltage such as pulse interval voltages V6a-e for the first five pulse intervals illustrated in FIG. 11. Drive voltage V6 may be controlled to be larger in magnitude than the back EMF voltage when the electric machine is being driven as a motor. Furthermore, the voltage of the pulses of the drive voltage V6 may be controlled to fairly closely approximate a desired optimum drive voltage curve 404 that may, for example, be similar in shape to, but slightly larger in magnitude than, back EMF curve 400.

In accordance with aspects of this disclosure, various operating characteristics of an electric machine may be optimized by controlling the shape of stepped drive voltage line 402 of FIG. 11 to be a close approximation of optimal drive voltage curve 404. Stepped drive voltage line 402 may be made to more closely approximate optimum drive voltage curve 404 by dividing the cycle into an increased number of pulse intervals. However, there are some energy losses associated with switching the pulse interval voltage for each pulse interval. Therefore, there is an optimum number of pulse intervals that may be used for the pulse width modulation for any given drive cycle that is a balance of using enough pulse intervals to approximate the optimum drive voltage curve as closely as possible to the electric machines back EMF signature and not using too many pulse intervals in order to limit the switching losses associated with switching the pulse interval voltage for each pulse interval.

As mentioned above, the back EMF of an electric machine is dependent upon the field-switching frequency or rotational speed of the machine. Therefore, the voltage curve of the back-EMF associated with a given cycle of an electric machine varies dramatically as the speed of the machine varies. As also mentioned above, there may be an optimal drive voltage curve associated with any given cycle of an electric machine and this optimum drive voltage curve may be similar to, but larger in magnitude than, the voltage curve of the back EMF. Therefore, the optimum drive voltages for a given electric machine may vary dramatically over the operating speed range of the electric machine.

The optimal drive voltage curve and the optimal number of pulse intervals described above may be determined in a wide variety of ways and remain within the scope of the present disclosure. For example, a specific drive system and electric machine design may be fully tested and characterize to determine the optimum drive voltages and switching speeds that are to be used for the full operating range of the system. This may include experimental testing of the specific design using a wide variety of drive voltages and pulse interval combinations to determine the optimal values for optimizing the desired operating characteristics of the system. Alternatively, certain characteristics of the system may be measured throughout the full range of operation of the system and this data may be used to establish a formula for calculating the optimum drive voltage curve and optimum number of pulse intervals. Some of the characteristics of the system that may be measured are the switching losses associated with the switching arrangement, the back EMF of the electric machine throughout the operational range of the machine, the inductance of various components of the machine, the location and spacing of the stator modules, or the resistance of the various groups of stator segment windings.

This approach of fully characterizing a system or electric machine may even be used to characterize manufacturing variations from machine to machine within a given electric machine design. In this case, each individual electric machine would be independently characterized to capture the implications associated with any manufacturing differences from machine to machine. This approach may be used to account for manufacturing variations such as variations in the air gap between the stator poles and rotor poles of different stator modules, differences in the spacing between stator modules and stator segments, or the resistance of groupings of windings.

The data obtained from the characterizing of the system or electric machine may be stored in a manner that is accessible to the controller. The controller may use this data to select a desired optimum set of drive voltages and switching speed for any given machine speed and requested power or torque input within the operating range of the electric machine. Alternatively, the data obtained from characterizing the system or electric machine may be used to establish formulas that may be made available to the controller during the operation of the system. The controller may use these formulas to calculate a desired optimum set of drive voltages and switching speed for any given machine speed and requested power or torque input within the operating range of the electric machine.

As described above, variable speed electric machines that include magnetic cores made from thin film soft magnetic material such as cores 220 of FIG. 4 are capable of operating at much higher field-switching frequencies compared to machines made using conventional iron cores. These field-switching frequencies may be as high as 2500 Hz compared to about 60 Hz in traditional AC powered electric motors or up to about 400 Hz for more specialized prior art motors. The use of much higher field-switching frequencies allows a given electric machine to operate over a much wider range of rotational speeds than is possible if lower conventional field-switching frequencies are used. Although the use of a wider range of frequencies such as 0-1500 Hz or as high as 0-2500 Hz allows a much wider range of rotational speeds for a given electric machine configuration, it may create some challenges and potential efficiency issues if conventional motor control approaches are used.

The controller methods of the present disclosure contemplate using very high pulse width modulation frequencies when it is appropriate to do so. This allows these controller methods to be used with electric machines that operate with extremely high motor frequencies such as those described immediately above. For example, a maximum pulse width modulation frequency of 100,000 Hz may be used to control an electric machine with a field switching operating range of 0-2500 Hz. This would allow up to forty pulse intervals while the electric machine is running at its maximum field-switching frequency of 2500 Hz. If this same pulse width modulation switching frequency of 100,000 Hz were used when the electric machine were operating at a lower motor speed such as a field-switching frequency of 100 Hz, this would result in 1000 pulse interval switches for each cycle of the motor which may incur significant unnecessary switching loses.

As described above, the controller method of present disclosure varies the drive voltage and switching speed used for the pulse width modulation to optimize an operating characteristic of the electric machine. This may include using an optimum number of pulse intervals associated with the current motor frequency or speed and the requested power or torque output to balance the switching losses with the gains associated with providing a drive voltage input that approximates as closely as possible an optimum drive voltage input curve as described for FIG. 11. Therefore, in the specific example described immediately above, the optimum switching speed used for the pulse width modulation when the electric machine is operating at a field-switching frequency of 100 Hz may again be forty pulse interval switches for each cycle of the motor. This would correspond to a pulse width modulation frequency of 4000 Hz rather than 100,000 Hz. Using this lower pulse width modulation frequency when the electric machine is operating at this lower speed may significantly reduce the switching loses associated with operating the electric machine at this lower speed This may significantly contribute to optimizing a particular operating characteristic of the electric machine such as the efficiency of the machine. Additionally, the optimal drive voltage curve associated with this lower speed operation may have a dramatically lower drive voltage magnitude compared to the drive voltage magnitudes associated with operating the electric machine at much higher speeds. Therefore, varying the drive voltages as described above to approximate the optimum drive voltage curve associated with a given electric machine operating speed, may also contribute very significantly to optimizing a particular operating characteristic of the electric machine when the machine is operating at that given speed.

Although the cycle of FIG. 11 was described as being divided into forty equal length pulse intervals for illustrative purposes, this is not a requirement. Instead, it should be understood that each cycle may be divided into any desired number of pulse intervals and these pulse intervals are not necessarily required to be equal in length within a given cycle. It should also be understood that the optimum number of pulse intervals and the optimum drive voltage curve associated with a specific cycle of a specific electric machine operating in a specific frequency and desired output may vary dramatically. Therefore, the present disclosure contemplates the use of any number of pulse intervals and the use of any appropriate drive voltage configuration in order to optimize a desired operating characteristic of an electric machine.

The use of a low loss core material such as thin film soft magnetic material and the use of the specific core configurations with no back iron magnetically interconnecting the independent cores as described above significantly reduces the back EMF associated with this type of electric machine compared to conventional electric machines. This lower back EMF, combined with the use of low loss core materials allows much faster field-switching frequencies to be used efficiently. This allows for a much wider frequency operating range or rotational speed range. The controller method described above allows the use of much higher pulse width modulation frequencies to accommodate the higher frequency made available by this type of electric machine while still maintaining high efficiency at lower speeds/frequencies by using lower pulse width modulation frequencies to reduce switching loses. For a given machine, the use of a wider range of frequencies also leads to wider range of optimum drive voltages. The controller method described above also allows the optimization of the drive voltage for any given speed throughout operating range of the electric machine.

The controller methods described above may also be applied to an electric machine having multiple independent sub-motors such as electric machine 202 of FIG. 2. In this situation, each sub-controller 110a-f may independently control its associated sub-motor using the above described controller methods. That is, each independent sub-controller 110a-f may vary both the drive voltages and the switching speeds used to drive the associated stator modules 214a-f to optimize desired operating characteristics of each sub-motor. Furthermore, the varying drive voltages and switching speeds used from sub-motor to sub-motor may be different for each sub-motor in order to compensate for any differences between the various sub-motors. These differences may include, but are not limited to, the size of the air gap between the stator poles and the rotor poles, the inductance of the components making up each sub-motor, the back EMF associated with each grouping of stator segments making up the stator module, the location of the stator modules within the electric machine, or any other differences in the characteristics of the sub-motors. For example, the above described method of fully characterizing an electric machine and using the data obtained from this characterization to control the operation of the machine may be used to compensate for the these differences in the sub-motors.

The method of fully characterizing an electric machine as described above may also allow the use of a single position detecting arrangement in the electric machine to provide a position signal to the controller regardless of number of stator modules included in the machine. With this approach, the timing differences associated with the field-switching of the stator poles in each of the different stator modules would be determined during the characterization of the machine. These timing differences would be provided to the overall master controller as part of the predetermined functions that the overall master controller uses to control the sub-controllers of the sub-motors. Using these timing differences, the overall master controller may coordinate the operation of each of the sub-controllers to compensate for the various positions of the stator modules within the electric machine.

As described above, electric machines in accordance with aspects of the present disclosure may use less than a full complement of stator modules. Additionally, specific stator module designs and electric machine designs may make it difficult to maintain a constant stator segment spacing between the stator segments at the ends of adjacent stator modules. Therefore, specific electric machine and stator module designs, such as the one illustrated in FIG. 2, may create a stator pole gap 254 that is larger than the stator segment spacing 250 in electric machine 202. The same approach describe above for determining the timing differences between different stator modules may be used to compensate for these larger stator pole gaps.

This approach of using multiple sub-motors and being able to compensate for different positions of the stator modules allows each stator module to be positioned such that it may be phase shifted relative to other stator modules. In other words, in a case where each stator module is configured to be a three phase device, each stator module may be positioned such that the three phases of that stator module are out of phase relative to the other stator modules. This allows each stator module to effectively add three additional phases to the motor. For example, a motor with six stator modules that each act as a three phase device may provide an eighteen phase overall device. This feature may be used to provide certain advantages such as a smoother operating motor with less torque ripple.

The controller methods described above may be used to optimize any desired operating characteristic or combination of characteristics of the system. For example, the efficiency of the system may be the operating characteristic that is optimized during normal operation of the electric machine. In certain high load situations, the operating characteristic that is optimized may be changed to optimize the power output of the system. Other operating characteristics such as the noise associated with the operation of the system or the temperature of the electric machine or energy storage modules may be monitored and the controller may be configured to optimize or control these characteristics when these characteristics reach a certain level. In another example, the state of charge of the electrical energy storage system may be monitored and the controller may be operated to limit the output of the drive system when the state of charge falls below a certain level.

Although the characterization of the electric machine has been described above as being done before the electric machine is put to use, this is not a requirement. Instead, various characteristics of the electric machine may be monitored during the use of the electric machine and these potentially changing characteristics may be incorporated into the characterization data that is used by the controller to determine the drive voltages and switching speeds to the used. This allows the system to adapt or adjust to variations in various characteristics of the electric machine that may change while the electric machine is in use. These characteristics may include, but are not limited to the temperature of the machine, the resistance of various electrical components of the machine, the impedance of various components of the machine, or any other machine characteristic. If desired, these characteristics may be continuously monitored and continuously updated and incorporated into the characterization data that is used by the controller to determine the drive voltages and pulse width modulation switching speeds used by the controller to control the electric machine.

A number of implementations of the present disclosure have been described. Nevertheless, it should be understood that various modifications may be made without departing from the spirit and scope of the present disclosure.

In a first example, each of the stator segments of the stator modules of an electric machine may have a stator segment spacing that does not correspond to a specific ratio relative to the rotor pole spacing. In this example, each stator segment may be wired to be independently controlled by its associated controller or sub-controller relative to the other stator segments. This would in effect allow each stator segment to be associated with its own electrical phase. The specific characteristics of each stator segment including air gap, inductance, resistance, spacing, and any other desired characteristic may be fully characterized as described above to allow each stator segment to be individually controlled using an optimum drive voltage curve and optimum switching speed that may be specific to that stator segment.

In another example, although the implementations described above have described the electric machine as being a radial gap, brushless DC machine, this is not a requirement. Instead, any desired electric machine configuration including an axial gap electric machine or any other suitable and readily providable electric machine may be used. Accordingly, other implementations are within the scope of the following claims.

Listing of Reference Numerals

| V1a-f | Module Operating Voltage |
|---|---|
| V2a-f | Output Voltage |
| V3 | Battery Cell Voltage |
| V4 | Drive Voltage |
| V5 | Auxiliary Module Operating Voltage |
| V6 | Drive Voltage |
| V6a-f | Pulse Interval Voltage |
| L | Length |
| 100 | Power Management System |
| 102 | Electrical Energy Storage System |
| 104a-f | Electrical Energy Storage Module |
| 106a-f | Electrical Power modulation Circuit |
| 108a-f | Output Arrangement |
| 110 | Controller |
| 110a-f | Sub-Controller |
| 111a-f | Electrical Conductors |
| 112 | Communication Bus |
| 113 | Electrical Energy Storage Component |
| 114 | Power Terminals |
| 115a-f | Charger |
| 116 | External Electrical Power Source |
| 117a-f | Buck/Boost Converter |
| 118 | Electric Machine |
| 120 | Rotor Assembly |
| 122 | Stator Assembly |
| 124 | Input Signal |
| 126 | Position Signal |
| 128 | Position Detecting Arrangement |
| 130 | Switching Arrangement |
| 132 | Electrical Conductors |
| 200 | Electric Drive System |
| 202 | Electric Machine |
| 204 | Rotor Assembly |
| 206 | Stator Assembly |
| 208 | Radial Gap |
| 210 | Rotational Axis |
| 212a-b | Permanent Magnets |
| 214a-f | Stator Modules |
| 216 | Stator Housing |
| 218a-f | Stator Segment |
| 220 | Core |
| 222 | Coil |
| 224 | Electrical Leads |
| 226 | Core Bracelet |
| 228 | Stator Pole Face |
| 230 | Winding |
| 232 | Layers |
| 234 | U-Shaped Layers |
| 236 | Arrow |
| 250 | Stator Segment Spacing |
| 252 | Arc |
| 254 | Stator Pole Gap |
| 258a-f | Conductors |
| 260a-f | Sub-Motors |
| 280 | Auxiliary Module |
| 282 | Electrical Conductors |
| 284 | Module Housing |
| 286 | Extrusion |
| 288 | Cross-Sectional Shape |
| 290 | Peripheral Wall |
| 292 | End Caps |
| 296 | Heat Dissipating Flange |
| 298 | Heat Dissipating Surface |
| 300 | Controller Method |
| 302 | Step |
| 304 | Step |
| 306 | Block |
| 308 | Step |
| 310 | Step |
| 400 | Back EMF Curve |
| 402 | Stepped Drive Voltage Curve |
| 404 | Optimum Drive Voltage Curve |

1. An electrical energy storage system comprising:
a plurality of electrical energy storage modules with each electrical energy storage module having an associated operating voltage, each electrical energy storage module being capable of outputting electrical power at a variable current at the associated operating voltage;
a plurality of electrical power modulation circuits, each electrical power modulation circuit being electrically connected to an associated one of the electrical energy storage modules thereby allowing the associated electrical energy storage module to be electrically isolated from the other electrical energy storage modules of the electrical energy storage system, each electrical power modulation circuit including an arrangement for receiving the operating voltage and current of the associated electrical energy storage module, transforming the operating voltage and current, and outputting electrical power at a voltage that is independent of the operating voltage of the associated electrical energy storage module; and
an overall master controller that is electrically connected to each of the electrical power modulation circuits of each electrical energy storage module to control the electrical power output from each of the electrical energy storage modules and thereby control the power output of the overall electrical energy storage system.

2.-45. (canceled)
